(19) United States
(12) Patent Application Publication
(10) Pub. No.: US 2002/0079384 A1
(43) Pub. Date: Jun. 27, 2002

(54) Liquid-gas ejector with an improved liquid nozzle and variants

(76) Inventor: Serguei A. Popov, Houston, TX (US)

Correspondence Address: MARK OATHOUT, Suite 830, 3730 Kirby Drive, Houston, TX, 77098, US

(21) Appl. No.: 10/037,091

(22) Filed: Oct. 22, 2001

Related U.S. Application Data
(63) Continuation-in-part of application No. 09/509,411, filed on Mar. 27, 2000, now abandoned.
Application No. 09/509,411 is a 371 of international application No. PCT/IB99/01309, filed on Jul. 23, 1999.

(30) Foreign Application Priority Data
Jul. 27, 1998 (RU) 98114642

(51) Int. Cl. B05B 7/04

(52) U.S. Cl. 239/433

(57) ABSTRACT

The present invention pertains to the field of jet technology and essentially relates to a liquid-gas jet ejector, which includes an axisymmetric liquid nozzle, a receiving chamber and an axisymmetric mixing chamber. In one embodiment of the ejector a flow-through channel of the liquid nozzle has an inlet section converging in the flow direction and an outlet section. The inlet and outlet sections of the nozzle flow-through channel are conjugated with each other defining a sharp edge in a zone of transition where a surface of the inlet section turns into a surface of the outlet section. There is another embodiment of the ejector, wherein the liquid nozzle has a flow-through channel composed of an inlet section converging in the flow direction, an outlet section and a curvilinear transition surface in a zone where the surface of the inlet section is joined to the surface of the outlet section. A radius of curvature of a generating curve of the curvilinear transition surface must not exceed 0.5 mm. The introduced liquid-gas ejectors furnished with the described liquid nozzles exhibit an improved efficiency because the nozzles provide for reduced energy losses during transformation of the potential energy of liquid pressure at the inlet of the nozzle into the kinetic energy of liquid jet at the outlet of the nozzle. At the same time, such nozzles have an improved manufacturability.

This application is a continuation-in-part of U.S. application Ser. No. 09/509,411 filed Mar. 27, 2000, which is a 35 U.S.C. 371 of International Application number PCT/IB99/01309 filed Jul. 7, 1999 (not published in English), now abandoned, which was based on application number RU 98114642 filed Jul. 7, 1998 (not published in English).

### BACKGROUND OF THE INVENTION

The present invention pertains to the field of jet technology, primarily to liquid-gas ejectors for producing a vacuum and compressing gaseous mediums in various industrial processes.

A liquid-gas ejector comprising a nozzle, a receiving chamber, a mixing chamber and a diffuser is known, whose nozzle constitutes a cylindrical channel with a curvilinear inlet edge (see, Certificate of authorship, USSR, 767405, MK 6 F04 F 5/04, 30.09.80).

Liquid-gas ejectors with the nozzles of this type are quite easy-to-manufacture. However, this kind of nozzle is unable to ensure complete transformation of the potential energy of pressure into the kinetic energy of a liquid flow. Therefore the liquid-gas ejectors equipped with such nozzles cannot achieve highest possible efficiency.

The starting point for the present invention is a liquid-gas ejector comprising a nozzle, a receiving chamber and a mixing chamber, wherein the nozzle has conjugate inlet and outlet sections. The inlet section of the nozzle constitutes a channel converging in the flow direction (see, “Impeller machines and Jet apparatuses” brochure, collection of articles, issue No. 5, Moscow, “Mashinostroenie” Publishing house, 1971, pages 266-267).

The surface of the flow-through channel of this nozzle is formed by rotation of a specially shaped curve around the nozzle axis. In this nozzle the potential energy of liquid pressure is transformed into the kinetic energy of the liquid jet with lesser losses. But the shaped surface of the flow-through channel of the nozzle is very expensive in manufacture, which results in a high cost for liquid-gas ejectors equipped with such nozzles.

### SUMMARY OF THE INVENTION

The objectives of the present invention are to increase efficiency of the liquid-gas ejector by reducing energy losses during transformation of the potential energy of liquid pressure at the nozzle inlet into the kinetic energy of a liquid jet at the nozzle outlet and to optimize the cost of manufacture of the ejector by improving manufacturability of the ejector nozzle.

The stated objectives are achieved as follows: a liquid-gas ejector comprising an axisymmetric liquid nozzle, a receiving chamber and an axisymmetric mixing chamber is furnished with the nozzle, whose flow-through channel has an inlet section converging in the flow direction and an outlet section. The inlet and outlet sections are joined with each other defining a sharp edge in the zone of transition of a surface of the inlet section into a surface of the outlet section.

There is another variant of the nozzle's design providing attainment of the stated objectives. In this embodiment, the liquid-gas jet ejector has a liquid nozzle, whose flow-through channel includes an inlet section converging in the flow direction and an outlet section mated with the inlet section through a curvilinear transition surface. The radius of curvature of a curve forming this transition surface must not exceed 0.5 mm.

Furthermore, the surface of the outlet section of the liquid nozzle can have a sharp outlet edge. The outlet section of the nozzle can be formed by a cylindrical surface, by a surface converging in the flow direction with the slope of the surface generating line to the nozzle axis that does not exceed 40° or by a surface diverging in the flow direction with the slope of the surface generating line to the nozzle axis that does not exceed 40°. The surface of the outlet section of the nozzle can have a curvilinear outlet edge, in this case the radius of curvature of a curve forming the surface of the outlet edge must not exceed 0.5 mm. The inlet convergent section of the nozzle can be formed by a conical surface or by a convex or concave curvilinear surface generated by rotation of a curve around the nozzle axis. In the latter case the radius of curvature of the generating curve must not exceed 500 mm. The inlet convergent section of the nozzle can be formed also by conjugate conical and cylindrical surfaces, which are mated through a curvilinear transition surface. The radius of curvature of a curve generating this transition surface must be from 0.5 mm to 8.0 mm.

Experimental research has shown, that shape of the transition surface, through which the conical and cylindrical portions of the convergent inlet section of the liquid nozzle of the liquid-gas ejector are mated, has significant influence on the process of forming of a liquid jet in the nozzle and consequently on performance of the liquid-gas ejector as a whole because exactly a liquid nozzle of the liquid-gas ejector provides conversion of a high-pressure liquid into a high-velocity liquid flow. With the use of expressions and dependences known from the hydrodynamics, it is possible to determine an “ideal” curvilinear surface of the flow-through channel of the nozzle, but such a surface will be very complex in manufacture due to the quite high surface finish and accuracy requirements. That is why in reality the surface of the channel is formed by conical and cylindrical surfaces so that it would fit the “ideal” surface as close as possible. Experiments have shown, that, however strange it looks, it is expedient to make the transition between the component surfaces of the channel as a sharp edge or as a curvilinear surface having a radius of curvature that does not exceed 0.5 mm. It is also expedient to make a sharp edge or a transition curve having a minimal radius of curvature between the surfaces forming the channel in the zones of the outlet and inlet cross-sections of the nozzle. The liquid-gas ejectors with various liquid nozzles were tested and their performance was analyzed. The tested nozzles had channels of various profiles, namely channels with a convergent inlet section combined with a cylindrical, convergent or divergent outlet section. The convergent inlet section could be formed by a conical surface or by a surface generated by rotation of a curve around the nozzle axis. It was determined that transition between the component surfaces of the flow-through channel of the nozzle which constitutes a sharp edge or a curvilinear surface having a radius of curvature that does not exceed 0.5 mm is most suitable for the nozzles having a cylindrical outlet section as well as for the nozzles having a convergent or divergent conical outlet section whose taper angle does not exceed 80°. When the inlet convergent section of the channel is formed by a curvilinear surface, a generating line of this surface must have a radius of curvature that does not exceed 500 mm. When the inlet convergent section of the nozzle is formed by a cylindrical surface turning into a conical surface, a generating line of the transition curvilinear surface between the two must have a radius of curvature that ranges from 0.5 mm to 8.0 mm.

Thus, the stated objectives have been achieved: the liquid nozzles with the above-described features provide for a more effective utilization of energy while their production is quite simple, therefore the liquid-gas ejectors furnished with such nozzles are more efficient and cost-effective.

### BRIEF DESCRIPTION OF THE DRAWINGS

FIG. 1 represents a schematic sectional view of a liquid-gas ejector whose liquid nozzle has a conical inlet section and a cylindrical outlet section.

FIG. 1A is an enlarged view of the liquid nozzle of FIG. 1.

FIG. 2 represents a schematic sectional view of a liquid-gas ejector whose liquid nozzle has a convergent outlet section.

FIG. 2A is an enlarged view of the liquid nozzle of FIG. 2

FIG. 3 represents a schematic sectional view of a liquid-gas ejector whose liquid nozzle has a divergent outlet section.

FIG. 3A is an enlarged view of the liquid nozzle of FIG. 3.

FIG. 4 represents a schematic sectional view of a liquid-gas ejector whose liquid nozzle has a curvilinear concave inlet section.

FIG. 4A is an enlarged view of the liquid nozzle of FIG. 4.

FIG. 5 represents a schematic sectional view of a liquid-gas ejector whose liquid nozzle has a curvilinear convex inlet section.

FIG. 5A is an enlarged view of the liquid nozzle of FIG. 5.

FIG. 6 represents a schematic sectional view of a liquid-gas ejector whose liquid nozzle has an inlet section formed by cylindrical and conical surfaces.

FIG. 6A is an enlarged view of the liquid nozzle of FIG. 6. For greater clarity some of the nozzles shown in the diagrams have a sharp edge in the zone of transition of the component surfaces and the rest of the nozzles have curvilinear transition surfaces.

### DETAILED DESCRIPTION

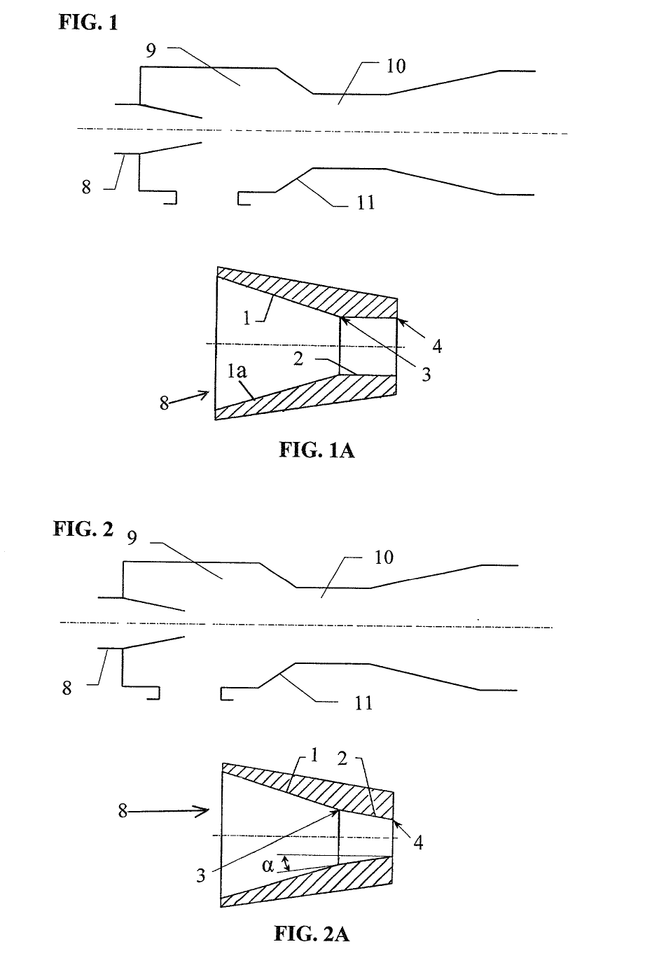

Referring to FIGS. 1 and 1A, a liquid-gas ejector 11 comprises an axisymmetric liquid nozzle 8 mounted adjacent a receiving chamber 9 and an axisymmetric mixing chamber 10 connected to the receiving chamber 9. The liquid nozzle 8 has a channel with an inlet section 1 which converges in the flow direction and an outlet section 2 which are joined with each other. The channel has a sharp (radius of curvature less than 0.020 of an inch) edge 3 at the turn or intersection of the surface of the inlet section 1 and surface of the outlet section 2. The surface of the outlet section 2 can have a sharp (radius of curvature less than 0.020 of an inch) outlet edge 4. The sharp edge 3 and sharp outlet edge 4 may be made with a CNC milling machine with accuracy of 0.0005 of an inch. The central hole is drilled and the surrounding hole area is machined. The same sequence may be used for the finishing, taking off from 0.080 to 0.005 of an inch. In a working example, the pressure of the motive liquid is 600 psi; the pressure of the suctioned gas is 15 psi; the diameter of the mixing chamber 10 is 1.2 inches; the length of the mixing chamber 10 is eight feet; and the discharge pressure of the motive liquid suctioned gas mixture is 150 psi. In this working example, the sharp edge 3 and sharp outlet edge 4 are critical for successful functioning of the liquid nozzle 8 in the liquid gas ejector 11.

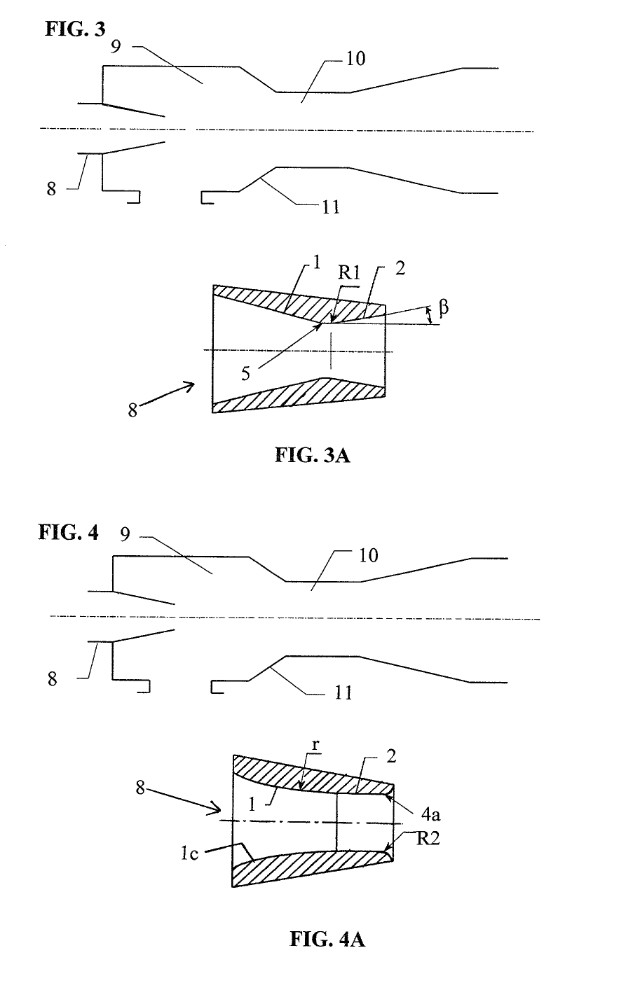

There is another variant of design of the liquid nozzle 8 of the liquid-gas ejector 11. In this variant shown in FIG. 3A a flow-through channel of the nozzle 8 is composed of an inlet section 1 converging in the flow direction and an outlet section 2 joined with each other, the flow-through channel has a curved transition surface 5 (formed by rotation of a concave curve around the nozzle's center axis) between the surface of the is inlet section 1 and the surface of the outlet section 2. The radius of curvature RI for this curved transition surface 5 does not exceed 0.5 mm.

The outlet section 2 of the liquid nozzle 8 may have different forms. First, it can be formed by a cylindrical surface (see FIG. 1A). Next, the nozzle 8 (see FIG. 2A) can have an outlet section 2 which converges in the flow direction. In this case the slope α of the 2S: surface generating line to the nozzle axis does not exceed 40°. Or, the nozzle 8 (see FIG. 3A) can have an outlet section 2 that diverges in the flow direction. In this case the slope β of the surface generating line to the nozzle axis does not exceed 40°.

It may be expedient if the outlet edge 4a of the outlet section 2 is curvilinear and formed in the lengthwise plane by a curve (see FIG. 4A), having a radius of curvature R2 which does not exceed 0.5 mm.

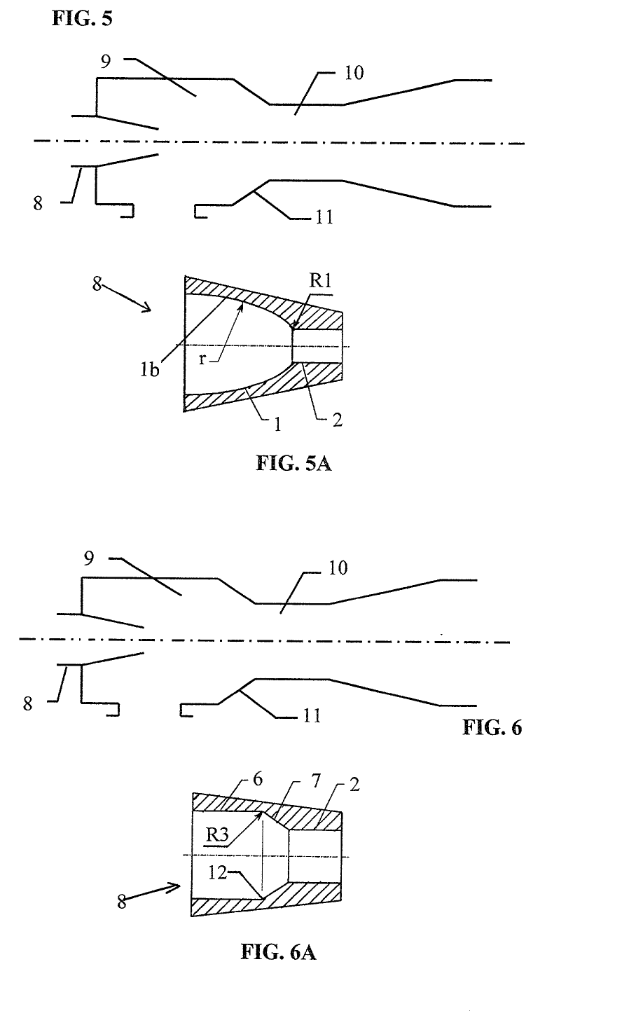

The inlet convergent section 1 of the nozzle 8 may have different forms. First, it can be formed by a conical surface 1a (see FIG. 1A). Next, the inlet convergent section 1 of the nozzle 8 can be formed by a convex curved surface 1b (see FIG. 5A) or by a concave (see FIG. 4A) curved surface 1c generated by rotation of a curve around the nozzle's center axis, where the radius of curvature “r” of the generating curve in this case does not exceed 500 mm. The inlet convergent section 1 can be formed also by a conjugate cylindrical surface 6 and conical surface 7 (FIG. 6A), which are mated by a curved transition surface 12. The radius of curvature R3 of a curve generating the curved transition surface 12 between the cylindrical surface 6 and conical surface 7 is from 0.5 mm to 8.0 mm.

The liquid-gas ejector 11 equipped with any of the introduced versions of the liquid nozzle 8 operates as follows.

A motive liquid is fed under an adjusted pressure into the convergent section 1 of the flow-through channel of the liquid nozzle 8, where the liquid flow is accelerated due to transformation of potential energy into kinetic energy. Then the flow passes to the outlet section 2 of the channel, where formation of the liquid flow is finalized and, wherefrom, a jet of the liquid is discharged into the mixing chamber 10. The liquid jet entrains an evacuated gaseous medium from an external source through the receiving chamber 9 into the mixing chamber 10. A gas-liquid flow is formed and simultaneously the gaseous component of the flow is compressed in the mixing chamber 10. Then the gas-liquid flow is discharged from the mixing chamber 10 of the liquid-gas ejector 11.

Industrial Applicability

The described invention can be applied in the industries where evacuation and compression of gaseous, vapor and gas-vapor mediums are required.

1. A liquid-gas ejector, comprising:
a receiving chamber;
an axisymmetric liquid nozzle mounted adjacent the receiving chamber; and
an axisymmetric mixing chamber connected to the receiving chamber;
wherein the axisymmetric liquid nozzle has a flow-through channel which comprises
an inlet section converging in a flow direction;
an outlet section;
a sharp edge interposing the inlet section converging in the flow direction to the outlet section; and
wherein the outlet section has a sharp outlet edge.

2. A liquid-gas ejector, comprising:
a receiving chamber;
an axisymmetric liquid nozzle mounted adjacent the receiving chamber; and
an axisymmetric mixing chamber connected to the receiving chamber;
wherein the axisymmetric liquid nozzle has a flow-through channel which comprises
an inlet section converging in a flow direction;
an outlet section;
a curved transition surface interposing the inlet section converging in the flow direction to the outlet section; and
wherein the curved transition surface has a radius of curvature which does not exceed 0.5 mm.

3. The liquid-gas ejector according to claim 2, wherein the outlet section is cylindrical.

4. The liquid-gas ejector according to claim 2, wherein the outlet section converges in the flow direction, defining a slope α which does not exceed 40°.

5. The liquid-gas ejector according to claim 2, wherein the outlet section diverges in the flow direction, defining a slope β which does not exceed 40°.

6. The liquid-gas ejector according to claim 2, wherein the outlet section has a curvilinear outlet edge, defining a radius of curvature which does not exceed 0.5 mm.

7. The liquid-gas ejector according to claim 2, wherein the inlet section converging in the flow direction is conical.

8. The liquid-gas ejector according to claim 2, wherein the inlet section converging in the flow direction has a convex curved surface, and wherein said convex curved surface defines a radius of curvature which does not exceed 500 mm.

9. The liquid-gas ejector according to claim 2, wherein the inlet section converging in the flow direction has a concave curved surface, and wherein said concave curved surface defines a radius of curvature which does not exceed 500 mm.

10. The liquid-gas ejector according to claim 2, wherein the inlet section converging in the flow direction comprises a conical surface; a cylindrical surface; and a second curved transition surface interposing the conical surface to the cylindrical surface and wherein said second curved transition surface has a radius of curvature which ranges from 0.5 mm to 8.0 mm.
